(19) United States
(12) Patent Application Publication
(10) Pub. No.: US 2026/0249135 A1
(43) Pub. Date: Aug. 27, 2026

(54) GEOFENCE BASED ACTIVITY TRACKING FOR GOLF COURSE

(71) Applicant: Textron Inc., Providence, RI (US)

(72) Inventors: Preston Sering Easley, Martinez, GA (US); Jonathan Luis Valdes, Graniteville, SC (US)

(73) Assignee: Textron Inc., Providence, RI (US)

(21) Appl. No.: 19/062,968

(22) Filed: Feb. 25, 2025

(51) Int. Cl. A63B 24/00

(52) U.S. Cl. CPC A63B 24/0021; A63B 2024/0056

(57) ABSTRACT

A golf course management system includes one or more processing circuits configured to establish a first area and a second area, monitor a location of a plurality of golf vehicles, provide a second graphical user interface on a second user device of each of the plurality of golf vehicles, provide, via the second graphical user interface, an advertisement when the location indicates that one or more golf vehicles are located in the first area and when the location indicates that one or more golf vehicles are located in the second area, and aggregate advertisement data associated with the advertisement. The advertisement data includes at least one of a view time of the advertisement based on a duration the advertisement is provided, an impression count of the advertisement based on a frequency the advertisement is provided, or a user interaction count of the advertisement based on user inputs with the advertisement.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Keep-out geofences may be established around areas of the golf course where the golf carts and other vehicles should not drive. These areas may include greens, tee boxes, buildings, water, woods, among others. When the golf cart or the other vehicles drive in the area defined by the keep-out geofence, the operation thereof may be limited. Advertisement geofences may be established around areas of the golf course such as cart paths and fairways where the golf carts and other vehicles drive. When the golf cart or the other vehicles drive in the area defined by the advertisement geofence, an advertisement may be provided thereto.

### SUMMARY

One embodiment relates to a golf course management system. The golf course management system includes one or more processing circuits configured to provide a first graphical user interface on a first user device, the first graphical user interface configured to facilitate establishing one or more areas based on one or more user inputs received from the first user device, establish a first area and a second area within a respective area based on the one or more user inputs, monitor a location of a plurality of golf vehicles relative to the first area and the second area, provide a second graphical user interface on a second user device of each of the plurality of golf vehicles, provide, via the second graphical user interface, an advertisement when the location indicates that one or more golf vehicles of the plurality of golf vehicles are located in the first area and when the location indicates that one or more golf vehicles of the plurality of golf vehicles are located in the second area, and aggregate advertisement data associated with the advertisement. The advertisement data includes at least one of a view time of the advertisement based on a duration the advertisement is provided via the second graphical user interface, an impression count of the advertisement based on a frequency the advertisement is provided via the second graphical user interface, or a user interaction count of the advertisement based on user inputs with the advertisement provided via the second graphical user interface.

Another embodiment relates to a golf course management system. The golf course management system includes one or more processing circuits configured to provide a first graphical user interface on a first user device, the first graphical user interface configured to facilitate establishing one or more areas based on one or more user inputs received from the first user device, establish a first area and a second area within a respective area based on the one or more user inputs, monitor a location of a plurality of golf vehicles relative to the first area and the second area, provide a second graphical user interface on a second user device of each of the plurality of golf vehicles, provide, via the second graphical user interface, an advertisement when the location indicates that one or more golf vehicles of the plurality of golf vehicles are located in the first area and when the location indicates that one or more golf vehicles of the plurality of golf vehicles are located in the second area, and aggregate advertisement data associated with the advertisement. The advertisement data including a view time of the advertisement based on a duration the advertisement is provided via the second graphical user interface, an impression count of the advertisement based on a frequency the advertisement is provided via the second graphical user interface, and a user interaction count of the advertisement based on user inputs with the advertisement provided via the second graphical user interface.

Still another embodiment relates to a golf course management system. The golf course management system includes one or more processing circuits configured to provide a first graphical user interface on a first user device, the first graphical user interface configured to facilitate establishing one or more geofences based on one or more user inputs received from the first user device, establish a first geofence and a second geofence within a respective area based on the one or more user inputs, monitor a location of a plurality of golf vehicles relative to the first geofence and the second geofence, provide a second graphical user interface on a second user device of each of the plurality of golf vehicles, provide, via the second graphical user interface, an advertisement when the location indicates that one or more golf vehicles of the plurality of golf vehicles are located in the first geofence and when the location indicates that one or more golf vehicles of the plurality of golf vehicles are located in the second geofence, aggregate advertisement data associated with the advertisement, identify a drivable area of the respective area at least partially overlapped by the first geofence or the second geofence based on the advertisement data and the location of a respective golf vehicle of the plurality of golf vehicles, and increase a frequency of advertisements provided via the second graphical user interface when the location indicates that the respective golf vehicle is in a high advertisement activity area.

Still another embodiment relates to a golf course management system. The golf course management system includes one or more processing circuits configured to monitor a location of a plurality of golf vehicles relative to a respective area, establish a first operation area around a first area of the respective area and a second operation area around a second area of the respective area, permit unrestricted operation of a respective golf vehicle of the plurality of golf vehicles when the location indicates that the respective golf vehicle is located outside of the first operation area and the second operation area, limit operation of the respective golf vehicle when the location indicates that the respective golf vehicle is located in the first operation area or the second operation area, determine a violation value associated with at least one of the first operation area or the second operation area, and modify the first operation area or the second operation area based on at least one of the location of the plurality of golf vehicles or the violation value. The first operation area and the second operation area are linked together such that a modification to (i) the first operation area is automatically applied to the second operation area and (ii) the second operation area is automatically applied to the first operation area.

Still another embodiment relates to a golf course management system. The golf course management system includes one or more processing circuits configured to monitor a location of a plurality of golf vehicles relative to a respective area, establish a restricted operation area within the respective area, permit unrestricted operation of a respective golf vehicle of the plurality of golf vehicles when the location indicates that the respective golf vehicle is located outside of the restricted operation area, limit operation of the respective golf vehicle when the location indicates that the respective golf vehicle is located in the restricted operation area, determine a violation value associated with the restricted operation area, wherein the violation value includes a number of instances of the plurality of golf vehicles crossing into the restricted operation area from a drivable area of the respective area, determine that the restricted operation area is established around or at least partially along the drivable area in response to the violation value exceeding a violation value threshold, and modify or suggest modifying the restricted operation area in response to determining that the restricted operation area is established around or at least partially along the drivable area such that the restricted operation area does not overlap the drivable area.

Still another embodiment relates to a golf course management system. The golf course management system includes one or more processing circuits configured to monitor a tracked location of a plurality of golf vehicles and a true location of the plurality of golf vehicles relative to a respective area, establish a restricted operation area within the respective area, permit unrestricted operation of a respective golf vehicle of the plurality of golf vehicles when the tracked location indicates that the respective golf vehicle is located outside of the restricted operation area, limit operation of the respective golf vehicle when the tracked location indicates that the respective golf vehicle is located in the restricted operation area, determine a violation value associated with the restricted operation area, wherein the violation value includes a number of instances of the plurality of golf vehicles crossing into the restricted operation area from a drivable area of the respective area, and modify or suggest modifying the restricted operation area in response to (i) the violation value exceeding a violation value threshold and (ii) the tracked location indicating that the respective golf vehicle is in the restricted operation area while the true location indicates that the respective golf vehicle is in the drivable area. Modifying the restricted operation area causes the tracked location to not indicate that the golf vehicle is in the restricted operation area.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a top view of a golf course including the vehicle of FIG. 1, according to an exemplary embodiment.

FIG. 6 is a top view of a golf course including the vehicle of FIG. 1, according to an exemplary embodiment.

FIG. 7 is a graphical user interface including a geofence establishing menu and a golf course view panel, according to an exemplary embodiment.

FIG. 8 is the graphical user interface of FIG. 7 including a group geofence panel, according to an exemplary embodiment.

FIG. 9 is a graphical user interface including an advertisement, according to an exemplary embodiment.

FIG. 10 is a top view of a golf course including a first geofence and a second geofence resized relative to a cart path of the golf course, according to an exemplary embodiment.

FIG. 11 is a top view of a golf course including a first geofence and a second geofence resized relative to a location of the vehicle of FIG. 1, according to an exemplary embodiment.

FIG. 12 is a top view of a golf course including a first geofence and a second geofence resized relative to a location of the vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

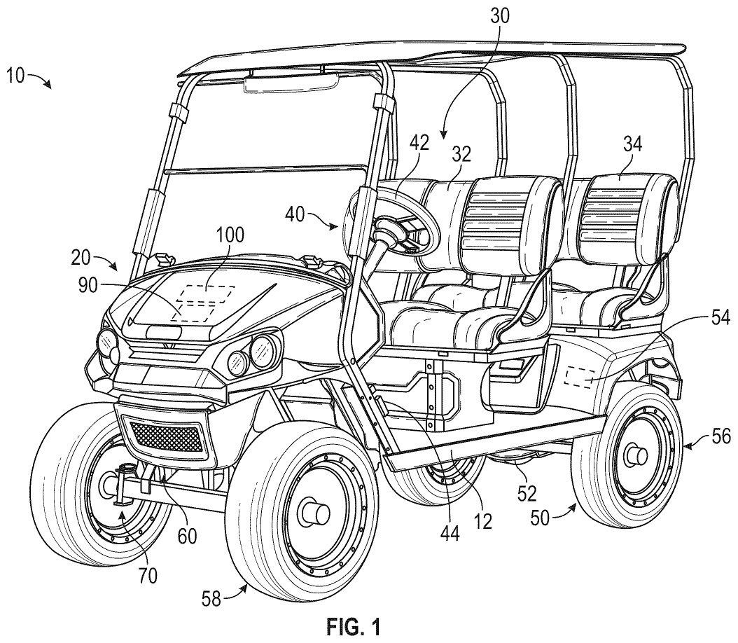

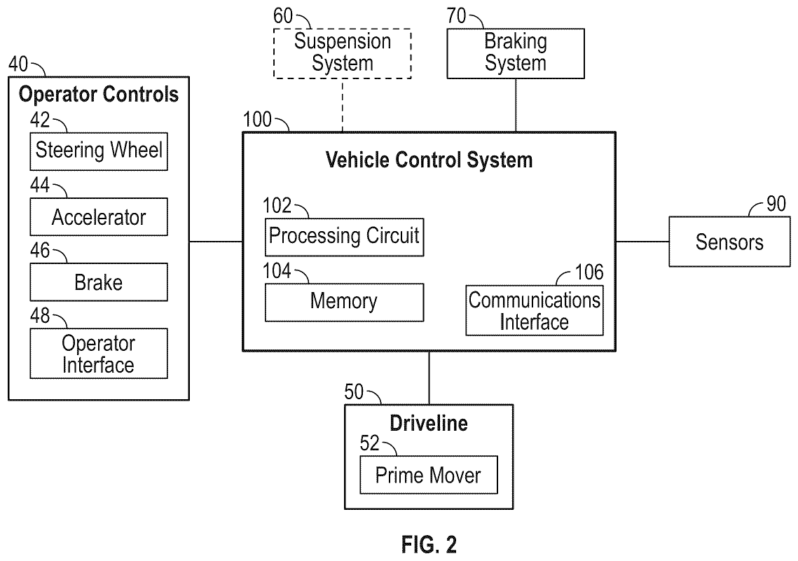

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

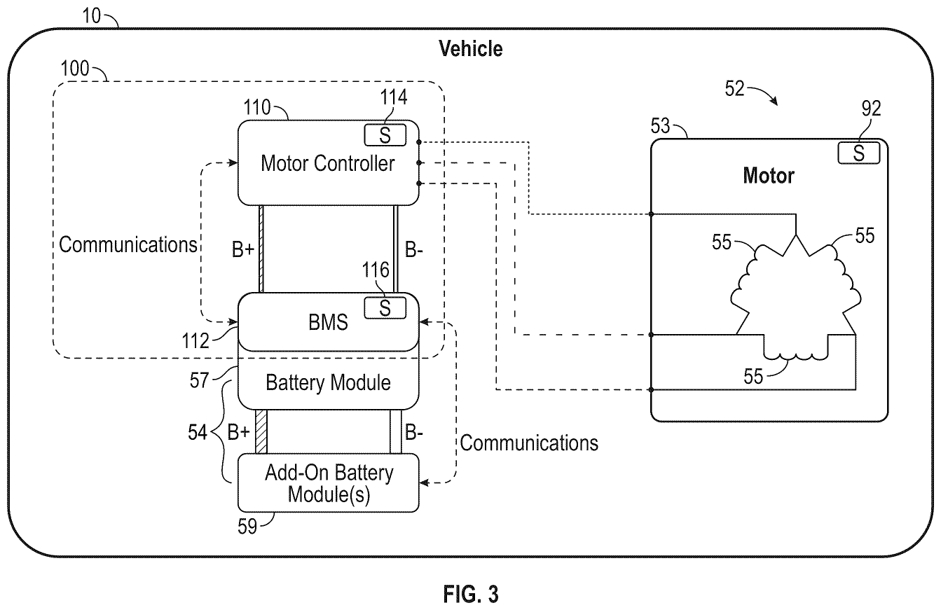

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

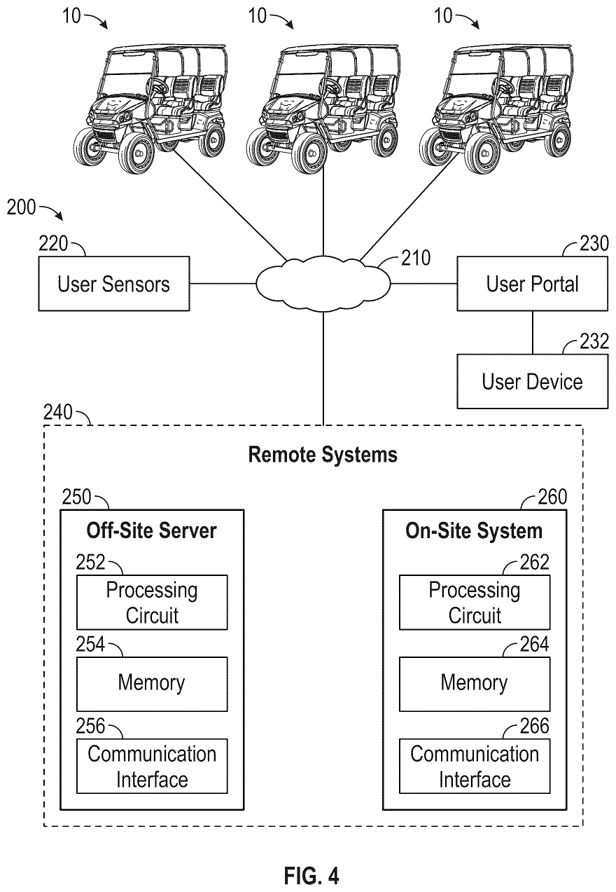

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Geofence Based Activity Tracking

According to an exemplary embodiment, the fleet monitoring and control system 200, including the vehicle control system 100, the user sensors 220, the user portal 230, and the remote systems 240, is configured to facilitate improving or enhancing location detection of the vehicles 10 and associated control thereof based on location. Further, it should be understood that any of the functions or processes described herein with respect to the fleet monitoring and control system 200 may be performed by the vehicle control system 100 and/or the remote systems 240. By way of example, data collection may be performed by the vehicle control system 100 and data analytics may be performed by the vehicle control system 100. By way of another example, data collection may be performed by the vehicle control system 100 and data analytics may be performed by the remote systems 240. By way of yet another example, data collection may be performed by the vehicle control system 100, a first portion of data analytics may be performed by the vehicle control system 100, and a second portion of data analytics may be performed by the remote systems 240. By way of still another example, a first portion of data collection may be performed by the vehicle control system 100, a second portion of data collection may be performed by the remote systems 240, and data analytics may be performed by the vehicle control system 100 and/or the remote systems 240.

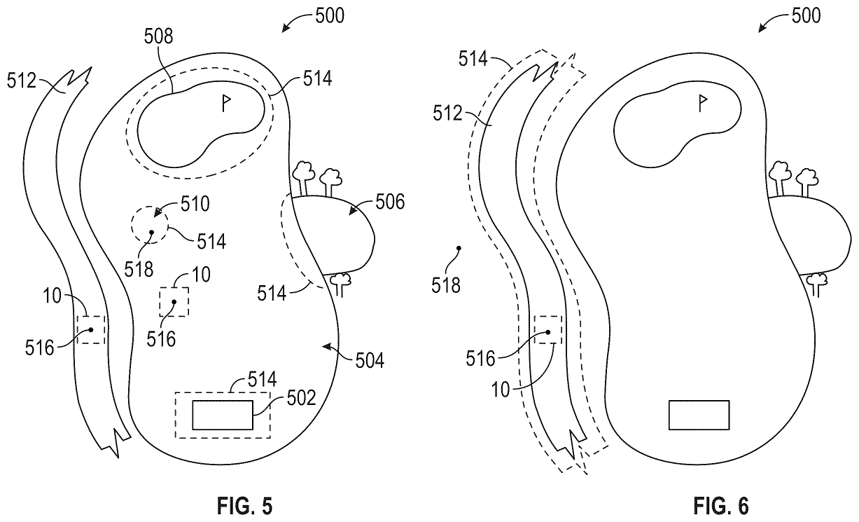

As shown in FIGS. 5 and 6, the vehicle 10 may be a golf cart driven by an operator playing golf on a golf course 500. In some embodiments, the vehicle 10 is a drink cart, a cart driven by an employee of the golf course 500 monitoring the pace of play of golfers, a cart driven by the maintenance crew working at the golf course 500, or another type of vehicle or vehicle commonly found at golf courses (e.g., a turf mower, a sprayer, an aerator, a bunker rake, etc.). A hole of the golf course 500 is shown including a tee box 502; a fairway 504; a water hazard, woods, fescue, etc., shown as out-of-bounds area 506; a putting green, shown as green 508; an area in the fairway 504 that is under repair, a non-playable area, etc., shown as hazard 510; and a path, a trail, a cart route, etc., shown as cart path 512.

The golf course 500 includes areas that should not be driven on, in, or around by the vehicle 10. By way of example, these areas may include the tee box 502, the out-of-bounds area 506, the fairway 504 during certain conditions (e.g., rain, flooding, under repair, etc.), the green 508, the hazard 510, private property along the golf course 500, a club house of the golf course 500, roped-off areas, dry/brown grass areas, areas with new sod, and/or another areas of the golf course 500. Driving on, in, or around these areas by the vehicle 10 may damage the golf course 500, be dangerous for an operator of the vehicle 10, damage the vehicle 10, be illegal (e.g., trespassing on private property), etc. Collectively, these areas are hereinafter referred to as restricted areas. Accordingly, one or more geofences (e.g., a virtual boundary, a virtual fence, etc.), shown as geofences 514, may be established around the restricted areas. The geofences 514 may be areas or boundaries defined around the restricted areas to control and manage the operation of the vehicle 10 on the golf course 500. By way of example, when the vehicle 10 is driven beyond the virtual boundary of the geofence 514 (i.e., driven into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). Areas of the golf course 500, such as the cart path 512, a parking lot of the golf course 500, the fairway 504, a cart return area, etc. that are not restricted areas defined by a geofence 514 may be drivable (e.g., navigable, permitted, unrestricted operation, etc.) by the vehicle 10, and are hereinafter referred to as the drivable areas. In some embodiments, a cart path only rule may be implemented where the vehicle 10 is supposed to drive on the cart path 512 only (e.g., after or during heavy rainfall). In such an embodiment, the geofence 514 may be established everywhere except for the cart path 512.

As shown in FIG. 6, the geofence 514 is established around the cart path 512. The geofence 514 formed around the cart path 512 may facilitate implementing the cart path only rule where the vehicle 10 is supposed to drive on the cart path 512 only (e.g., after or during heavy rainfall, to avoid ground under repair, when the cart path 512 is a bridge crossing a river/pond, etc.). As shown in FIG. 6, rather than defining geofences 514 around the restricted areas (i.e., everywhere but the cart path 512), a geofence 514 (e.g., a cart path geofence) is formed around the cart path 512. By way of example, when the vehicle 10 is driven beyond the virtual boundary of the geofence 514 (i.e., driven off of the cart path 512 and into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). In some embodiments, the geofences 514 are established around the restricted areas (as shown in FIG. 5) and around the drivable areas (e.g., around the cart path 512 as shown in FIG. 6).

According to an exemplary embodiment, a location of the vehicle 10 is monitored by the fleet monitoring and control system 200 to determine the location of the vehicle 10 relative to the geofence 514, the restricted areas, and the drivable areas. The location of the vehicle 10 may be determined based on GPS data (e.g., collected by the sensors 92 and/or the user sensors 220). The fleet monitoring and control system 200 may be configured to store the location data and analyze the location data to make operational decisions based thereon.

In some embodiments, a real-time position (e.g., corrected position, actual location, etc.), shown as true location 516, of the vehicle 10 is different than a GPS location, shown as tracked location 518, of the vehicle 10 determined based on the GPS data. The error or difference between the tracked location 518 of the vehicle 10 and the true location 516 of the vehicle 10 may be caused by signal interference (e.g., geomagnetic radiation), solar storms, signal obstruction (e.g., tree cover, building cover, etc.), weather (e.g., rain, snow, pressure, etc.), control system quality, malfunctioning sensors, and/or any other combination of internal hardware or external factors. The difference between the tracked location 518 and the true location 516 may be referred to herein as location or GPS drift. Because of the difference between the tracked location 518 and the true location 516, the fleet monitoring and control system 200 may determine, based on the GPS position, that the vehicle 10 is operating in the restricted area (e.g., near/on a green or tee box, near/on a hazard such as ground under repair, an area defined by a geofence, a non-drivable area, etc.) when in reality, the true location 516 of the vehicle 10 is not in the restricted area. In such an example, the fleet monitoring and control system 200 may undesirably limit the operation of the vehicle 10. Similarly, because of the difference between the tracked location 518 and the true location 516, the fleet monitoring and control system 200 may determine, based on the GPS position, that the vehicle 10 is not operating in the restricted area (e.g., operating in the drivable area) when in reality, the true location 516 of the vehicle 10 is in the restricted area. In such an example, the fleet monitoring and control system 200 may undesirably permit operation of the vehicle 10 within the restricted area.

According to an exemplary embodiment, the fleet monitoring and control system 200 is configured to correct (e.g., adjust for, account for, etc.) the undesirable controlling of the operation of the vehicles 10 as a result of the GPS drift. By way of example, the fleet monitoring and control system 200 may be configured to force the tracked location 518 to be within the drivable area in response to a determination, based on the true location 516, that the vehicle 10 is traveling in the drivable area and the tracked location 518 indicates that the vehicle 10 is in the restricted area. By way of another example, the fleet monitoring and control system 200 may be configured to force the tracked location 518 to be within the restricted area in response to a determination, based on the true location 516, that the vehicle 10 is traveling in the restricted area and the tracked location 518 indicates that the vehicle 10 is in the drivable area. By way of another example, the fleet monitoring and control system 200 may be configured to control operation of the vehicle 10 based on a corrective position determined using RTK information. In such an example, the corrective position may be based on corrective position data determined based on (i) communications between the on-site system 260 and a satellite (e.g., a global navigation satellite system (GNSS) satellite) and (ii) a known, fixed location of the on-site system 260. By way of yet another example, the fleet monitoring and control system 200 may be configured to control operation of the vehicle 10 based on the type of surface the vehicle 10 is driving on. In some embodiments, when a determination is made that the true location 516 is different than the tracked location 518 (e.g., the coordinates are different), the fleet monitoring and control system 200 may be configured to recalibrate (e.g., reset) the sensors 90 collecting the GPS data and/or send a signal commanding the user sensors 220 to recalibrate.

The fleet monitoring and control system 200 may control an operation of the operator controls 40, the driveline 50, the suspension system 60, the braking system 70, and/or any other component of the vehicle 10 based on the true location 516 of the vehicle 10 relative to the restricted areas and the drivable areas. By way of example, the fleet monitoring and control system 200 may determine, based on the true location 516, that the vehicle 10 is operating (e.g., driving forward, driving backward, idling, stopped, parked, etc.) (i) in a drivable area defined by a respective geofence 514, (ii) near a respective geofence 514 (e.g., within 5 yards of the respective geofence 514, within 10 yards of the respective geofence 514, etc.), or (iii) in a restricted area defined by a respective geofence 514. In response to a determination that the vehicle 10 is operating in a drivable area, the fleet monitoring and control system 200 may facilitate (e.g., permit operation of the vehicle 10 in a first mode of operation) normal or unrestricted operation of the operator controls 40, the driveline 50, the suspension system 60, the braking system 70, and/or any other component of the vehicle 10. In response to a determination that the vehicle 10 is operating in or near a restricted area (e.g., near or in the geofence 514), the fleet monitoring and control system 200 may (i) limit operation (e.g., limit operation of the vehicle 10 in a second mode of operation) of the operator controls 40, the driveline 50, the suspension system 60, the braking system 70, and/or any other component of the vehicle 10 and/or (ii) provide an alert (e.g., visually or audibly via the operator interface 48, in a tactile manner by shaking the steering wheel 42, etc.) to the operator of the vehicle 10 indicative of the location of the restricted area (e.g., a boundary of the geofence 514). By way of example, the monitoring and control system 200 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In such an example, to transition the vehicle 10 to the second mode of operation, the fleet monitoring and control system 200 may (i) shift the vehicle 10 into neutral (e.g., such that no power is transmitted to the prime mover 52) and/or (ii) operate the braking system 70 to slow the vehicle 10 to a stop. The vehicle 10 may be limited to the second mode of operation until the vehicle 10 navigates (e.g., is navigated by an operator) to the drivable area.

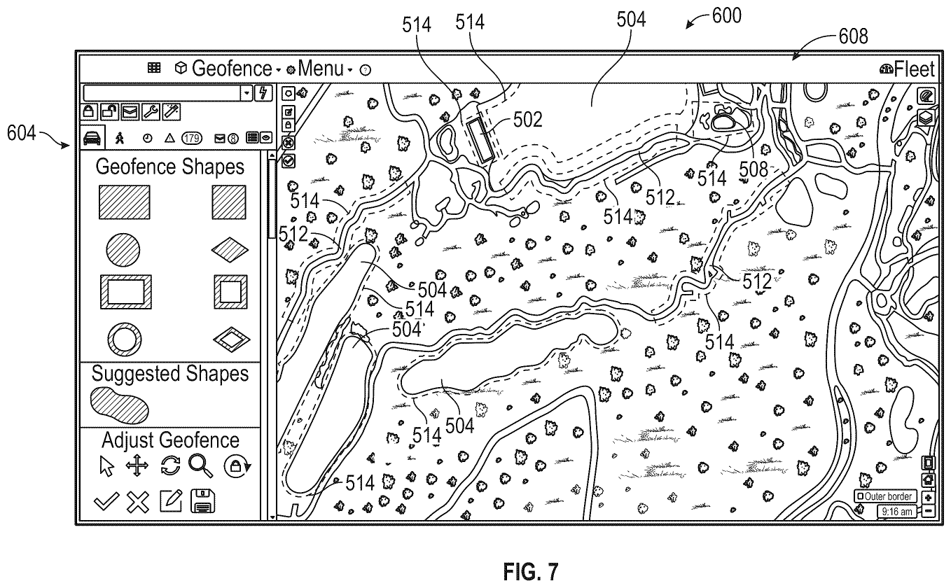

As shown in FIGS. 7-9, a graphical user interface (“GUI”), shown as geofence GUI 600, is configured to provide one or more views, menus, buttons, etc., to facilitate establishing, shaping, and configuring the settings of one or more of the geofences 514 around the restricted areas and/or the drivable areas of the golf course 500. The geofence GUI 600 is configured to be provided to the operator interface 48 and/or the user device 232 for display on the one or more displays thereof. The operator interface 48 and/or the user device 232 are configured to receive an input from the user to provide the user with the ability to control one or more functions of and/or provide commands to the geofence GUI 600 and the fleet monitoring and control system 200. By way of, the user may interact with (e.g., engage with, provide an input to, etc.) the geofence GUI 600 via the operator interface 48 and/or the user device 232 to cause the geofence GUI 600 to display one or more additional elements, menus, panels, etc.

As shown in FIG. 7, the geofence GUI 600 includes a geofence shaping and adjustment menu (e.g., restricted operation area feature), shown as geofence establishing menu 604, and a golf course information panel (e.g., a hole view panel, a hole information panel, a course view panel, etc.), shown as golf course view panel 608. According to an exemplary embodiment, the geofence establishing menu 604 is configured to provide the user with the ability to establish the geofences 514 on the golf course 500 around the restricted areas and/or the drivable areas. Establishing a geofence 514 as discussed herein may include creating a new geofence 514, selecting and editing a shape of the geofence 514 (e.g., a new geofence 514 and a previously created geofence 514), selecting and editing a size of the geofence 514, and/or moving (e.g., translating, rotating, etc.) the geofence 514 about the golf course 500, among other controls relating to establishing the geofence 514.

As shown in FIG. 7, the golf course view panel 608 includes a map of the golf course 500. The golf course view panel 608 is configured to display (i) the tee box 502, the fairway 504, the out-of-bounds area 506, the green 508, the hazard 510, etc. of one or more holes, (ii) the cart path 512, (iii) the geofences 514 established on the golf course 500, and (iv) any other features of the golf course 500. The user may interact with the golf course view panel 608 to zoom in to view a particular area of the golf course 500, zoom out to view a larger area of the golf course 500, pan across the map to view different areas of the golf course 500, rotate the map, and/or otherwise interact with the golf course view panel 608 to manipulate a view of the golf course 500 displayed by the golf course view panel 608. In some embodiments, the user provides an input to the golf course view panel 608 specifying a respective hole of the golf course 500, and the golf course view panel 608 is configured to display the respective hole. In some embodiments, the user provides an input to the golf course view panel 608 selecting one or more of the geofences 514 established on the golf course 500. In such embodiments, the user may move, resize, configure the settings, or otherwise edit the selected geofences 514. In some embodiments, the golf course view panel 608 is configured to display real-time updates regarding the locations of the vehicles 10 on the golf course 500.

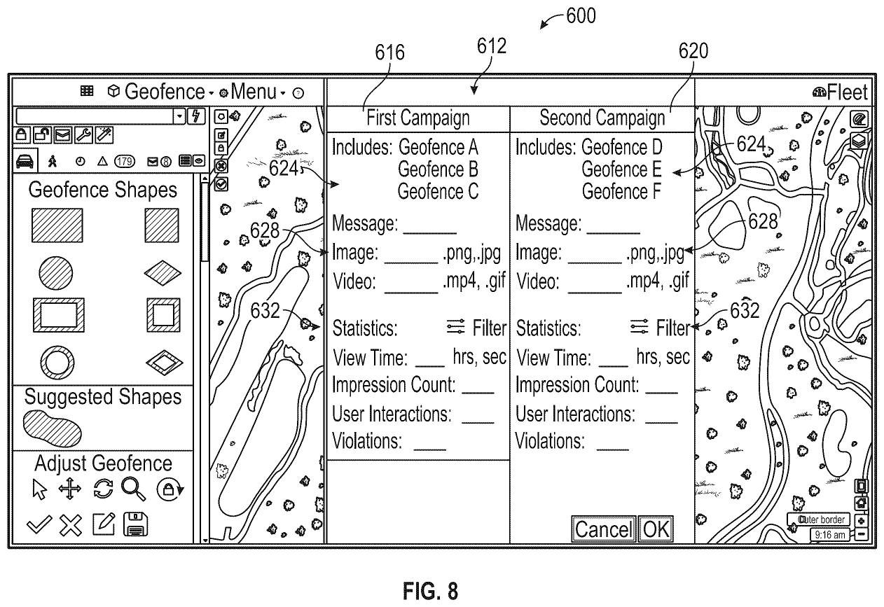

As shown in FIG. 8, the geofence GUI 600 is configured to display a geofence settings and statistics menu, shown as group geofence panel 612, configured to provide the user with the ability to configure one or more settings of one or more geofences 514 (e.g., settings of a single geofence 514, settings of a group of geofences 514, geofence campaigns, etc.) and view one or more statistics associated with the one or more geofences 514. In some embodiments, the group geofence panel 612 is displayed in response to an input by the user to establish a geofence 514. In other embodiments, the group geofence panel 612 is displayed in response to an input by the user to an edit button. In yet other embodiments, the group geofence panel 612 is displayed in response to a selection by the user, via the golf course view panel 608, of one or more of the geofences 514.

As shown in FIG. 8, the group geofence panel 612 is configured to provide the user with the ability to configure one or more settings and/or view one or more statistics of one or more geofences 514. According to an exemplary embodiment, the geofences 514 are configured to be grouped in (e.g., assigned to, designated in, etc.) one or more sub-sets (e.g., groups) of geofences 514, shown as first campaign 616 and second campaign 620. While shown in FIG. 8 as including the first campaign 616 and the second campaign 620, it should be understood that any number of groups of geofences 514 (e.g., campaigns) may be established (e.g., formed, generated, etc.) throughout the golf course 500. As shown in FIG. 8, the group geofence panel 612 is configured to provide the user with the ability to configure one or more settings and/or view one or more statistics of the first campaign 616, the second campaign 620, and/or any other one or more groups of geofences 514.

In some embodiments, the geofences 514 are grouped in the first campaign 616 or the second campaign 620 based on a type of the geofences 514 such that the group geofence panel 612 provides the user with the ability to configure one or more settings and/or view one or more statistics of the geofences 514 based on the type of the geofences 514. The type of the geofences 514 may include a keep-out geofence, a keep-in geofence (e.g., a cart path only geofence), an advertisement geofence, a message geofence, or another type of geofence. According to an exemplary embodiment, as a keep-out geofence, the fleet monitoring and control system 200 may limit operation of the vehicle 10 in the second mode of operation when the location indicates that the vehicle 10 is in the area (e.g., the restricted area) defined by the keep-out geofence. As a keep-in geofence, the fleet monitoring and control system 200 may (i) permit unrestricted operation of the vehicle 10 when the location indicates that the vehicle 10 is in the area (e.g., the drivable area) defined by the keep-in geofence and (ii) limit operation of the vehicle 10 in the second mode of operation when the location indicates that the vehicle 10 is outside of the area (e.g., in the restricted area) defined by the keep-in geofence. As an advertisement geofence, the fleet monitoring and control system 200 may provide an advertisement (e.g., a picture, a video, an audio file, the advertisement 636, etc.) to the operator interface 48 and the occupants within the vehicle 10 when the location indicates that the vehicle 10 is in the area defined by the advertisement geofence. As a message geofence, the fleet monitoring and control system 200 may provide a message (e.g., a text alert, a video alert, an audio alert, etc.) to the operator interface 48 and the occupants within the vehicle 10 when the location indicates that the vehicle 10 is in the area defined by the message geofence. By way of example, the geofences 514 configured as keep-out geofences may be grouped in the first campaign 616, the geofences 514 configured as keep-in geofences may be grouped in the second campaign 620, the geofences 514 configured as advertisement geofences may be grouped in a third campaign, and the geofences 514 configured as message geofences may be grouped in a fourth campaign. In such an example, the group geofence panel 612 may provide the user with the ability to configure the settings and/or view the statistics of all keep-out geofences in the first campaign 616, all keep-in geofences in the second campaign 620, all advertisement geofences in the third campaign, and all message geofences in the fourth campaign.

In some embodiments, a first sub-set of geofences 514 of a respective type are grouped in the first campaign 616 and a second sub-set of geofences 514 of the respective type are grouped in the second campaign 620. By way of example, a first sub-set of advertisement geofences may be grouped in the first campaign 616 (e.g., a first advertisement campaign) and a second sub-set of advertisement geofences may be grouped in the second campaign 620 (e.g., a second advertisement campaign). In such an example, the fleet monitoring and control system 200 may provide (i) a first advertisement to the operator interface 48 and the occupants within the vehicle 10 when the location indicates that the vehicle 10 is in the area defined by the geofences 514 in the first campaign 616, and (ii) a second advertisement to the operator interface 48 and the occupants within the vehicle 10 when the location indicates that the vehicle 10 is in the area defined by the geofences 514 in the second campaign 620.

In some embodiments, the geofences 514 are grouped in the first campaign 616 or the second campaign 620 based on a location of the geofences 514 such that the group geofence panel 612 provides the user with the ability to configure one or more settings and/or view one or more statistics of the geofences 514 based on the location of the geofences 514. The location of the geofences 514 may include a respective hole of the golf course 500 such that the geofences 514 established on the respective hole of the golf course 500 are grouped in the first campaign 616, the second campaign 620, or another campaign. By way of example, a first hole (e.g., Hole 1) of the golf course 500 may include geofences 514 established around the tee box 502 of the first hole, the fairway 504 of the first hole, the out-of-bounds area 506 extending along the first hole, the green 508 of the first hole, one or more hazards 510 of the first hole, and/or portions of the cart path 512 extending along the first hole. In such an example, the various geofences 514 established on the first hole may be grouped in the first campaign 616. Similarly, a second hole (e.g., Hole 2) of the golf course 500 may include geofences 514 established around the tee box 502 of the second hole, the fairway 504 of the second hole, the out-of-bounds area 506 extending along the second hole, the green 508 of the second hole, one or more hazards 510 of the second hole, and/or portions of the cart path 512 extending along the second hole. In such an example, the various geofences 514 established on the second hole may be grouped in the second campaign 620. In some embodiments, a number of campaigns (e.g., groups of the geofences 514) corresponds with a number of holes at the golf course 500. By way of example, golf courses 500 with eighteen holes may include the geofences 514 grouped in eighteen campaigns, with each campaign of the eighteen campaigns (i) corresponding to a respective hole of the eighteen holes of the golf course 500, and (ii) including the geofences 514 established on the respective hole of the golf course 500.

In some embodiments, the geofences 514 are grouped in the first campaign 616 or the second campaign 620 based on a type of feature around which the geofences 514 are established such that the group geofence panel 612 provides the user with the ability to configure one or more settings and/or view one or more statistics of the geofences 514 based on the type of feature around which the geofences 514 are established. The type of feature around which the geofences 514 are established may the tee box 502, the fairway 504, the out-of-bounds area 506, the green 508, one or more hazards 510, and/or the cart path 512, among other features of the golf course 500. By way of example, the geofences 514 (e.g., tee box geofences) established around the tee boxes 502 of the golf course 500 may be grouped in the first campaign 616, the geofences 514 (e.g., fairway geofences) established around the fairways 504 of the golf course 500 may be grouped in the second campaign 620, the geofences 514 (e.g., out-of-bounds area geofences) established around the out-of-bounds areas 506 of the golf course 500 may be grouped in a third campaign, the geofences 514 (e.g., green geofences) established around the greens 508 of the golf course 500 may be grouped in a fourth campaign, the geofences 514 (e.g., hazard geofences) established around the one or more hazards 510 of the golf course 500 may be grouped in a fifth campaign, and the geofences 514 (e.g., cart path geofences) established around the cart path 512 of the golf course 500 may be grouped in a sixth campaign.

Although the geofences 514 are described above as being grouped based on the type of the geofences 514, the location of the geofences 514, and the type of feature around which the geofences 514 are established, it should be understood that the geofences 514 may be grouped in the first campaign 616, the second campaign 620, or any other group of geofences 514 for any other reason. Further, it should be understood that a respective geofence 514 may be included in two or more groups of geofences 514. In other words, a respective geofence 514 may be included in at least the first campaign 616 and the second campaign 620. By way of example, a respective geofence 514 (i) of a respective type (e.g., a keep-out geofence, a keep-in geofence, an advertisement geofence, a message geofence, etc.), (ii) located at a respective location (e.g., a respective hole of the golf course 500), and (iii) established around a respective type of feature of the golf course 500 (e.g., the tee box 502, the fairway 504, the out-of-bounds area 506, the green 508, the one or more hazards 510, the cart path 512, etc.) may be grouped in at least (i) the first campaign 616 with other geofences 514 of the respective type, (ii) the second campaign 620 with other geofences 514 located at the respective location, and (iii) a third campaign with other geofences 514 established around the respective type of feature of the golf course 500.

In some embodiments, the geofences 514 are grouped in the first campaign 616 and/or the second campaign 620 in response to one or inputs by a user to the geofence GUI 600. By way of example, the user may select a plurality of geofences 514 displayed on the golf course view panel 608, and the fleet monitoring and control system 200 may be configured to establish a campaign (e.g., the first campaign 616 and/or the second campaign 620) including the selected plurality of geofences 514. By way of another example, the user may select (i) a plurality of geofences 514 displayed on the golf course view panel 608 and (ii) the first campaign 616 and/or the second campaign 620, and the fleet monitoring and control system 200 may be configured to add the selected plurality of geofences 514 to the selected first campaign 616 and/or second campaign 620.

In some embodiments, the geofences 514 are automatically grouped in the first campaign 616 and/or the second campaign 620 by the fleet monitoring and control system 200. By way of example, the fleet monitoring and control system 200 may be configured to automatically detect the location of where the geofences 514 are established (e.g., which hole of the golf course 500 that the geofences 514 are established) based on map data, vision data (e.g., satellite imagery, sensor data from the sensors 90 such as cameras, optical sensors, image recognition, machine vision, machine learning, artificial intelligence, etc.), etc. and automatically group the geofences 514 in the first campaign 616, the second campaign 620, and/or another group based on the detected location. By way of another example, the fleet monitoring and control system 200 may be configured to automatically detect the type of feature of the golf course 500 (e.g., the tee box 502, the fairway 504, the out-of-bounds area 506, the green 508, the one or more hazards 510, the cart path 512, etc.) around which the geofences 514 are established based on map data, vision data (e.g., satellite imagery, sensor data from the sensors 90 such as cameras, optical sensors, image recognition, machine vision, machine learning, artificial intelligence, etc.), etc. and automatically group the geofences 514 in the first campaign 616, the second campaign 620, and/or another group based on the detected type of feature.

As shown in FIG. 8, the group geofence panel 612 is configured to provide the user with the ability to configure one or more settings and/or view one or more statistics of the first campaign 616 and the second campaign 620. In some embodiments, the group geofence panel 612 is configured to provide the user with the ability to configure one or more settings and/or view one or more statistics of any other one or more groups of geofences 514. In some embodiments, the user selects a respective group of geofences 514 (e.g., the first campaign 616, the second campaign 620, etc.) via the golf course view panel 608, and the geofence GUI 600 displays the group geofence panel 612 to provide the user with the ability to configure one or more settings and/or view one or more statistics of the respective group of geofences 514. In some embodiments, the geofence GUI 600 displays the group geofence panel 612 in response to the establishment of a new geofence 514 and/or in response to a geofence 514 being added to the first campaign 616 and/or the second campaign 620.

According to an exemplary embodiment, inputs to the group geofence panel 612 update settings to the first campaign 616 and/or the second campaign 620. By way of example, the user may provide an input to the group geofence panel 612 identifying settings of the first campaign 616 and/or the second campaign 620, and the fleet monitoring and control system 200 may be configured to update the identified settings of each of the geofences 514 grouped in the first campaign 616 and/or the second campaign 620, respectively. As such, identifying the settings of the first campaign 616 and/or the second campaign 620 facilitates updating settings of a plurality of geofences 514 without needing to update the settings of each geofence 514 of the plurality of geofences 514 independently. The settings associated with the groups of geofences 514 (e.g., the first campaign 616, the second campaign 620, etc.) and configurable via the group geofence panel 612 may include a name of the groups of geofences 514, a name of the geofences 514 included in the first campaign 616 and the second campaign 620, a type of the geofences 514 included in the first campaign 616 and the second campaign 620, a geofence schedule, and/or a type of the vehicle 10 that the geofences 514 included in the first campaign 616 and the second campaign 620 affect, among other settings.

As shown in FIG. 8, the group geofence panel 612 includes a first menu, shown as geofence identification menu 624, configured to display the geofences 514 (e.g., the names of the geofences 514) included in the first campaign 616 and the second campaign 620. In some embodiments, the geofence identification menu 624 provides the user with the ability to add or remove one or more geofences 514 to the first campaign 616 and/or the second campaign 620. In some embodiments, the geofence identification menu 624 provides the user with the ability to edit the names of the groups of geofences 514 and/or the geofences 514 included therein. The groups of geofences 514 and/or the geofences 514 may be named based on the type of the geofences 514, the location of the geofences 514, the type of feature around which the geofences 514 are established, or named for any other reason.

As shown in FIG. 8, the group geofence panel 612 includes a second menu, shown as media menu 628, configured to provide the user with the ability to select media (e.g., messages, images, videos, etc.) to be provided to the operator interface 48 and the occupants within the vehicle 10. The group geofence panel 612 facilitates selecting and providing (i) first media (e.g., a first message, a first image, a first video, etc.) to vehicles 10 when the location indicates that the vehicle 10 is in the area defined by the geofences 514 included in the first campaign 616 and (ii) second media (e.g., a second message, a second image, a second video, etc.) different than the first media to vehicles 10 when the location indicates that the vehicle 10 is in the area defined by the geofences 514 included in the second campaign 620. In some embodiments, the user provides (e.g., types) a text message via the media menu 628 to be provided to the operator interface 48 and the occupants within the vehicle 10. By way of example, the respective geofences 514 included in the first campaign 616 and/or the second campaign 620 may be message geofences such that when the location indicates that the vehicle 10 is in the area defined by the respective geofences 514, the text message provided via the media menu 628 is provided to the operator interface 48 and the occupants within the vehicle 10. In some embodiments, the user selects (e.g., uploads) an image and/or a video via the media menu 628 to be provided to the operator interface 48 and the occupants within the vehicle 10. In such embodiments, the image and/or video may include an advertisement from an advertiser. By way of example, the respective geofences 514 included in the first campaign 616 and/or the second campaign 620 may be or include advertisement geofences such that when the location indicates that the vehicle 10 is in the area defined by the respective geofences 514, the image and/or video selected via the media menu 628 is provided to the operator interface 48 and the occupants within the vehicle 10.

The group geofence panel 612 may be configured to provide the user with the ability to selectively enable or disable the geofences 514 included in the first campaign 616 and/or the second campaign 620. By way of example, in response to an input from the user to the group geofence panel 612 to disable the first campaign 616 and/or the second campaign 620, the fleet monitoring and control system 200 may remove or deactivate the geofences 514 included in the first campaign 616 and/or the second campaign 620 such that (i) operation of the vehicle 10 is permitted in the first mode of operation responsive to crossing into a respective geofence 514 included in the first campaign 616 and/or the second campaign 620, and/or (ii) the vehicle 10 may not receive the advertisement or message responsive to crossing into a respective geofence 514 included in the first campaign 616 and/or the second campaign 620. Similarly, in response to an input from the user to the group geofence panel 612 to enable the first campaign 616 and/or the second campaign 620, the fleet monitoring and control system 200 may establish or activate the geofences 514 included in the first campaign 616 and/or the second campaign 620 such that (i) operation of the vehicle 10 is limited to the second first mode of operation responsive to crossing into a respective geofence 514 included in the first campaign 616 and/or the second campaign 620, and/or (ii) the vehicle 10 receives the advertisement or message responsive to crossing into a respective geofence 514 included in the first campaign 616 and/or the second campaign 620.

The group geofence panel 612 may be configured to provide the user with the ability to set a schedule of when the first campaign 616 and/or the second campaign 620 are enabled by the fleet monitoring and control system 200. By way of example, during the hours of operation of the golf course 500, the geofences 514 included in the first campaign 616 and the second campaign 620 established throughout the golf course 500 may operate normally (e.g., permitting or limiting operation of the vehicle 10, providing an advertisement, providing messages, etc., based on respective configurations of respective campaigns). By way of another example, outside the hours of operation of the golf course 500, the geofences 514 included in the first campaign 616 and established throughout the golf course 500 may transition to define restricted areas such that operation of the vehicle 10 is only permitted in the drivable areas, and the geofences 514 included in the second campaign 620 and established throughout the golf course 500 may operate normally.

The group geofence panel 612 may be configured to provide the user with the ability to set a level of restrictedness for the geofences 514 included in the first campaign 616 and/or the second campaign 620. By way of example, first respective geofences 514 included in the first campaign 616 may be configured such that operation of the vehicle 10 is permitted in the first mode of operation when the location indicates that the vehicle 10 is in the area defined by the first respective geofences 514, and second respective geofences 514 included in the second campaign 620 may be configured such that operation of the vehicle 10 is limited in the second mode of operation when the location indicates that the vehicle 10 is in the area defined by the second respective geofences 514. By way of another example, the first respective geofences 514 included in the first campaign 616 may be configured such that operation of the vehicle 10 is limited in the second mode of operation when the location indicates that the vehicle 10 is in the area defined by the first respective geofences 514, and second respective geofences 514 included in the second campaign 620 may be configured such that operation of the vehicle 10 is limited in a third mode of operation more restrictive than the second mode of operation when the location indicates that the vehicle 10 is in the area defined by the second respective geofences 514. More restrictive control may include limiting operation of the prime mover 52 such that the vehicle 10 (i) cannot exceed a first threshold speed when the location indicates that the vehicle 10 is in the area defined by the second respective geofences 514 while the vehicle 10 cannot exceed a second threshold speed greater than the first threshold speed when the location indicates that the vehicle 10 is in the area defined by the first respective geofences 514, (ii) is limited to rearward travel when the location indicates that the vehicle 10 is in the area defined by the second respective geofences 514 while the vehicle 10 is not limited to rearward travel when the location indicates that the vehicle 10 is in the area defined by the first respective geofences 514, and/or (iii) any other control to limit operation of the vehicle 10 when the location indicates that the vehicle 10 is in the area defined by the first respective geofences 514 in a manner that is more restrictive than the operation of the vehicle 10 when the location indicates that the vehicle 10 is in the area defined by the second respective geofences 514.

The group geofence panel 612 may be configured to provide the user with the ability to set a frequency of the advertisements or messages provided to the vehicle 10 responsive to crossing into a respective geofence 514 included in the first campaign 616 and/or the second campaign 620. By way of example, first respective geofences 514 included in the first campaign 616 may be configured such that the vehicle 10 is provided advertisements or messages at a first frequency when the location indicates that the vehicle 10 is in the area defined by the first respective geofences 514, and second respective geofences 514 included in the second campaign 620 may be configured such that the vehicle 10 is provided advertisements or messages at a second frequency greater than the first frequency when the location indicates that the vehicle 10 is in the area defined by the second respective geofences 514. In such an example, a frequency of the advertisements or messages provided to the vehicle 10 may include a number of instances the advertisements or messages are provided, a duration of how long the advertisements or messages are provided, or the like.

The group geofence panel 612 may be configured to provide the user with the ability to set the type of the vehicle 10 that the geofences 514 included in the first campaign 616 and/or the second campaign 620 affect. In other words, (i) the operation of the vehicle 10 may be permitted or limited or (ii) the advertisement and/or message may or may not be provided to the vehicle 10 depending on the type of the vehicle 10. By way of example, a first vehicle type may be permitted to operate in the first mode of operation responsive to crossing into a respective geofence 514 included in the first campaign 616 and a second vehicle type may be limited to the second mode of operation responsive to crossing the same respective geofence 514. In such an example, a vehicle 10 configured as a lawnmower configured to cut the grass on the green 508 (i.e., a vehicle 10 of the first vehicle type) may be permitted to operate in the first mode of operation, while a golf cart driven by a golfer (i.e., a vehicle 10 of the second vehicle type) may be limited to the second mode of operation responsive to crossing the same respective geofence 514 (e.g., to prevent certain types of vehicles 10 from operating in certain areas). Further, in such an example, the first vehicle type may be limited to operate in the second mode of operation responsive to crossing into a respective geofence 514 included in the second campaign 620 and the second vehicle type may be limited to the second mode of operation responsive to crossing the same respective geofence 514. By way of another example, a first vehicle type may not receive the advertisement responsive to crossing into a respective geofence 514 included in the first campaign 616 and a second vehicle type may receive the advertisement responsive to crossing the same respective geofence 514. In such an example, a vehicle 10 configured as a drink cart, a cart driven by an employee of the golf course 500 monitoring the pace of play of golfers, a cart driven by the maintenance crew working at the golf course 500, a lawnmower, a turf mower, a push mower, a ride-on mower, a stand-on mower, an aerator, a turf sprayer, a bunker rake, and/or another type of chore product (i.e., a vehicle 10 of the first vehicle type) may not receive the advertisement, while a golf cart driven by a golfer (i.e., a vehicle 10 of the second vehicle type) may receive the advertisement responsive to crossing the same respective geofence 514.

The group geofence panel 612 may be configured to provide the user with the ability to set a credential level of the operator of the vehicle 10 that the geofences 514 included in the first campaign 616 and/or the second campaign 620 affect. In other words, (i) the operation of the vehicle 10 may be permitted or limited or (ii) the advertisement and/or message may or may not be provided to the vehicle 10 depending on the credentials associated with the vehicle 10 and/or the credentials of the operator of the vehicle 10 (e.g., thereby selectively restricting access to certain areas of the golf course 500, thereby selectively advertising to golfers, etc.). By way of example, responsive to crossing into a geofence 514 included in the first campaign 616, (i) the vehicle 10 may be operable in the first mode of operation (or limited to the second mode of operation) if the operator (e.g., an employee) of the vehicle 10 is authorized to enter the area defined by the geofence 514 or (ii) the vehicle 10 may be limited to the second mode of operation (or a mode of operation more restrictive than the second mode of operation) if the operator (e.g., a golfer) of the vehicle 10 is not authorized to enter the area defined by the geofence 514.

As shown in FIG. 8, the group geofence panel 612 includes a third menu, shown as statistics menu 632, configured to provide the user with the ability to view one or more statistics associated with the first campaign 616, the second campaign 620, and/or any other one or more groups of geofences 514. In some embodiments, the fleet monitoring and control system 200 is configured to store data (e.g., the statistics) associated with the first campaign 616, the second campaign 620, and/or any other one or more groups of geofences 514. In embodiments where the geofences 514 included in the first campaign 616 and/or the second campaign 620 are advertisement geofences, the statistics menu 632 is configured to provide the user with the ability to view one or more statistics associated with an engagement of the operator of the vehicle 10 (to which the advertisement is provided) with the provided advertisement.

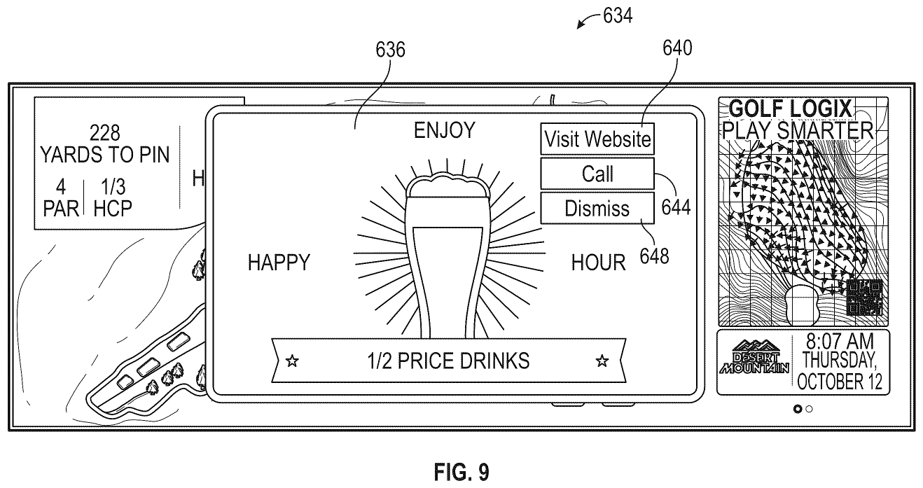

As shown in FIG. 9, a graphical user interface, shown as vehicle GUI 634, is configured to provide one or more views, menus, buttons, etc., to facilitate providing an operator of the vehicle 10 with the availability to view information associated with the golf course 500 (e.g., hole information, yardage information, etc.) and information provided to the vehicle 10. The vehicle GUI 634 may be provided to the operator interface 48 for display on the one or more displays thereof. As shown in FIG. 9, the vehicle GUI 634 is configured to display media (e.g., an advertisement, an image, a video, a message, etc.), shown as advertisement 636. As discussed in greater detail above, the advertisement 636 may be displayed on the vehicle GUI 634 responsive to the vehicle 10 crossing the boundary of an advertisement geofence. The fleet monitoring and control system 200 may provide (i) a first advertisement 636 to the operator interface 48 and the occupants within the vehicle 10 when the location indicates that the vehicle 10 is in the area defined by the geofences 514 in the first campaign 616, and (ii) a second advertisement to the operator interface 48 and the occupants within the vehicle 10 when the location indicates that the vehicle 10 is in the area defined by the geofences 514 in the second campaign 620. As shown in FIG. 9, the advertisement 636 includes a first button, shown as visit element 640, a second button, shown as call element 644, and a third element, shown as dismiss element 648. In some embodiments, the advertisement 636 includes more or fewer elements than shown in FIG. 9.

The operator interface 48 may be configured to receive an input from the operator of the vehicle 10 to provide the operator with the ability to control one or more functions of and/or provide commands to the vehicle GUI 634 and the fleet monitoring and control system 200. In some embodiments, the operator interacts with (e.g., engages with, provides an input to, etc.) the vehicle GUI 634 via the operator interface 48 to cause the vehicle GUI 634 to display one or more additional elements, menus, panels, etc., or to control the fleet monitoring and control system 200. By way of example, the operator may provide an input to the visit element 640 to cause the vehicle GUI 634 do display a website associated with the advertisement 636 (e.g., a website of the advertiser providing the advertisement 636). By way of another example, the operator may provide an input to the call element 644 to place a call with the advertiser providing the advertisement 636 (e.g., to call the clubhouse when the advertisement is provided by the clubhouse). By way of still another example, the operator may provide an input to the dismiss element 648 to dismiss the advertisement 636 (e.g., remove the advertisement 636 from being displayed by the vehicle GUI 634). In some embodiments, the advertisement 636 is automatically dismissed (e.g., removed) responsive to the vehicle 10 exiting an advertisement geofence or after a certain amount of elapsed time. Inputs to the visit element 640, the call element 644, the dismiss element 648, and/or any other input to the advertisement 636 may be hereinafter referred to as “user interactions.”

As shown in FIG. 8, the statistics menu 632 is configured to display statistics associated with the advertisement 636 (e.g., a first advertisement 636 displayed when the location indicates that the vehicle 10 is in the area defined by the geofences 514 in the first campaign 616, a second advertisement 636 displayed when the location indicates that the vehicle 10 is in the area defined by the geofences 514 in the second campaign 620, etc.) including a view time of the advertisement 636, an impression count of the advertisement 636, and user interactions with the advertisement 636, among other statistics associated with the advertisement 636.

The view time of the advertisement 636 may include a total duration of time that the advertisement 636 is displayed on the vehicle GUI 634 in one or more vehicles 10 (e.g., before the advertisement 636 is dismissed responsive to an input to the dismiss element 648). By way of example, the advertisement 636 may be provided to a first vehicle 10 for a first duration when the location indicates that the first vehicle 10 is in the area defined by the geofences 514 of the first campaign 616 or the second campaign 620, and to a second vehicle 10 for a second duration when the location indicates that the second vehicle 10 is in the area defined by the geofences 514 of the first campaign 616 or the second campaign 620. In such an example, the view time of the advertisement 636 may be a summation of the first duration and the second duration.

The impression count of the advertisement 636 may include a total number of instances (e.g., a total count) of the advertisement 636 being provided to a vehicle 10 for display by the vehicle GUI 634. By way of example, each instance of a vehicle 10 entering a geofence 514 of the first campaign 616 or the second campaign 620, and thereby causing the fleet monitoring and control system 200 to provide the advertisement 636 to the vehicle 10, may count as an impression. In some embodiments, the fleet monitoring and control system 200 links golfer data (e.g., a tee sheet) including a number of occupants of the vehicle 10 with the impression count data to determine the impression count. By way of example, based on the tee sheet, the fleet monitoring and control system 200 may determine that two occupants are in a respective vehicle 10 such that each instance of the respective vehicle 10 entering a geofence 514 of the first campaign 616 or the second campaign 620, and thereby causing the fleet monitoring and control system 200 to provide the advertisement 636 to the respective vehicle 10, may count as two impressions (e.g., one impression for each occupant in the respective vehicle 10). In such an example, the impression count may be based on the number of individuals in the vehicle 10 and the frequency the advertisement is provided to the vehicle 10.

The user interactions with the advertisement 636 may include a total number of instances that the operator of the vehicle 10 interacted with the advertisement 636. As discussed above, inputs to the visit element 640, the call element 644, the dismiss element 648, and/or any other input to the advertisement 636 may count as a user interaction with the advertisement 636.

In some embodiments, the fleet monitoring and control system 200 is configured to aggregate other statistics associated with the advertisement 636 such as conversion statistics (e.g., a percentage of occupants who redeem offers or make purchases after viewing the advertisement 636, sales or revenue generated from the advertisement 636, etc.) and advertisement performance statistics (e.g., most effective formats (e.g., picture or video) of the advertisement 636). In some embodiments, the advertisement performance statistics include a comparison of the view time, impression count, user interactions, and other statistics between the first campaign 616 and the second campaign 620 (and any other group of geofences 514). Based on the comparison of statistics between the first campaign 616 and the second campaign 620, the fleet monitoring and control system 200 (or the user) may determine areas of the golf course 500 that are high advertisement activity areas or high-traffic areas (e.g., based on greater view time, impression count, and user interactions) and areas of the golf course 500 that are low advertisement activity areas or low-traffic areas (e.g., based on less view time, impression count, and user interactions). By way of example, the first campaign 616 may include geofences 514 located at a first hole of the golf course 500 and the second campaign 620 may include geofences 514 located at a second hole of the golf course 500. Based on the advertisement statistics, the fleet monitoring and control system 200 may determine that the first hole is a high advertisement activity area and that the second hole is a low advertisement activity area (e.g., because the first campaign 616 has greater view time, impression count, and user interactions than the second campaign 620). In some embodiments, the fleet monitoring and control system 200 may identify one or more cart paths 512 (or another feature or drivable area of the golf course 500) that pass through a respective group of geofences 514. By way of example, the fleet monitoring and control system 200 may be configured to determine, based on the location of the vehicle 10 and the advertisement, a cart path 512 that is at least partially overlapped by one or more geofences 514 included in the first campaign 616 or the second campaign 620.

In some embodiments, the fleet monitoring and control system 200 is configured to provide the advertisement 636 to the vehicle 10 based on the advertisement statistics. By way of example, the fleet monitoring and control system 200 may provide the advertisement 636 to the vehicle 10 at a first frequency when the location indicates that the vehicle 10 is in the geofences 514 of the first campaign 616, and at a second frequency less than the first frequency when the location indicates that the vehicle 10 is in the geofences 514 of the second campaign 620. In some embodiments, the fleet monitoring and control system 200 modifies (e.g., adjusts), based on the advertisement data, the location, size, or shape of one or more geofences 514 in a campaign (e.g., the first campaign 616, the second campaign 620, etc.) to increase the view time, impression count, and user interactions with the advertisement 636.

In embodiments where the geofences 514 included in the first campaign 616 and/or the second campaign 620 are keep-out geofences and/or keep-in geofences, the statistics menu 632 is configured to provide the user with the ability to view one or more statistics associated with a violation value (e.g., violation count) based on the location of a vehicle 10. Violations may include the vehicle 10 crossing a boundary of a geofence 514 from a drivable area to a restricted area. By way of example, a violation may include when the vehicle 10 is driven beyond the virtual boundary of the geofence 514 (i.e., driven into a restricted area such as a tee box 502, a out-of-bounds area 506, a green 508, a hazard 510, etc.). By way of another example, when the geofence 514 is configured as a cart path only geofence (e.g., a keep-in geofence), a violation may include when the vehicle 10 is driven beyond the virtual boundary of the geofence 514 (i.e., driven off of the cart path 512 and into a restricted area). The violations displayed by the group geofence panel 612 may include a total number of violations across each geofence 514 included in a respective campaign (e.g., the first campaign 616, the second campaign 620, etc.). By way of example, the first campaign 616 may include a first geofence 514 and a second geofence 514, and the violation count displayed by the group geofence panel 612 may include a summation of the violations of vehicles 10 crossing a boundary of the first geofence 514 from the drivable area to the restricted area and the violations of vehicles 10 crossing a boundary of the second geofence 514 from the drivable area to the restricted area.

Based on the violation data, the fleet monitoring and control system 200 (or a user analyzing the violation data) may determine violation frequency, violation time patterns (e.g., time of day, day of the week, season, etc. when violations are most frequent), violation location (e.g., which campaigns or geofences 514 included therein have irregular violation counts), type of vehicle violating (e.g., a golf cart driven by a golfer, a vehicle driven by an employee of the golf course 500, etc.), violation duration (e.g., how long the vehicle 10 stays in the restricted area after entering the restricted area), repeat violations (e.g., a number of violations associated with a particular vehicle 10, a particular operator of the vehicle 10, etc.), among other metrics. In some embodiments, the fleet monitoring and control system 200 modifies, based on the violation data, the location, size, or shape of one or more geofences 514 in a campaign (e.g., the first campaign 616, the second campaign 620, etc.). By way of example, based on the violation data, the fleet monitoring and control system 200 may (i) identify areas of the golf course 500 where violations are not being triggered, but should be being triggered (e.g., areas that are or should be restricted areas, but are not limiting operation of the vehicles 10 driving therein), and (ii) modify the location, size, or shape of one or more geofences 514 (e.g., keep-out geofences) to surround the identified areas. By way of another example, based on the violation data, the fleet monitoring and control system 200 may (i) identify areas of the golf course 500 where violations are being triggered, but should not be being triggered (e.g., areas that are or should be drivable areas, but are limiting operation of the vehicles 10 driving therein), and (ii) modify the location, size, or shape of one or more geofences 514 (e.g., keep-out geofences) to exclude the identified areas. In some embodiments, the fleet monitoring and control system 200 modifies, based on the violation data, the settings (e.g., rules) associated with one or more geofences 514 in a campaign (e.g., the first campaign 616, the second campaign 620, etc.). By way of example, based on the violation data, the fleet monitoring and control system 200 may transition the geofences 514 between being enabled and disabled. By way of another example, based on the violation data, the fleet monitoring and control system 200 may modify the type of vehicle 10 that the geofences 514 affect.

The fleet monitoring and control system 200 may be configured to provide an alert in response to a violation of a vehicle 10 (e.g., in response to the vehicle 10 crossing into a keep-out geofence, in response to the vehicle 10 leaving a keep-in geofence, etc.). In some embodiments, the alert includes a visual or audible alert provided to the operator of the vehicle 10 via the operator interface 48, or a haptic alert provided to the operator of the vehicle 10 in a tactile manner by shaking the steering wheel 42 or their seat. In some embodiments, the alert includes a visual or audible alert provided to the on-site system 260 (e.g., to a user such as an employee at a clubhouse of the golf course 500). In some embodiments, the alert is provided (e.g., to the operator of the vehicle 10, to the on-site system 260, etc.) in response to the violations exceeding a violation threshold. By way of example, the violation threshold may be a violation count threshold, such that when a number of violations (e.g., violation instances) of a respective geofence 514 or a total number of violations for a respective campaign exceed the violation count threshold, the alert is provided. By way of another example, the violation threshold may be a threshold of a percentage of vehicles 10 committing a violation within a duration of time (e.g., a predetermined timeframe), such that when the percentage of vehicles 10 committing a violation in a respective geofence 514 or a respective campaign exceed the violation threshold, the alert is provided. In such an example, providing the alert based on the percentage of vehicles 10 committing a violation may account for busier or slower days (e.g., days with more golfers, days with fewer golfers, etc.). By way of yet another example, the violation threshold may be a violation duration threshold, such that when a violation duration of a respective geofence 514 exceeds the violation duration threshold, the alert is provided. In some embodiments, the violation threshold varies depending on one or more conditions. By way of example, the violation threshold may vary based on weather such that the violation threshold is lower during poor weather conditions (e.g., while it is raining or after it has rained, rained more than 1 inch in a 24 hour period, after a rain event, etc.) such that the alert is provided more often than during or after normal weather conditions (e.g., non-rainy weather conditions). By way of another example, the violation threshold may vary based on an event (e.g., member-only outing, public golf time, tournaments, etc.) such that the alert is provided more or less often during the event.

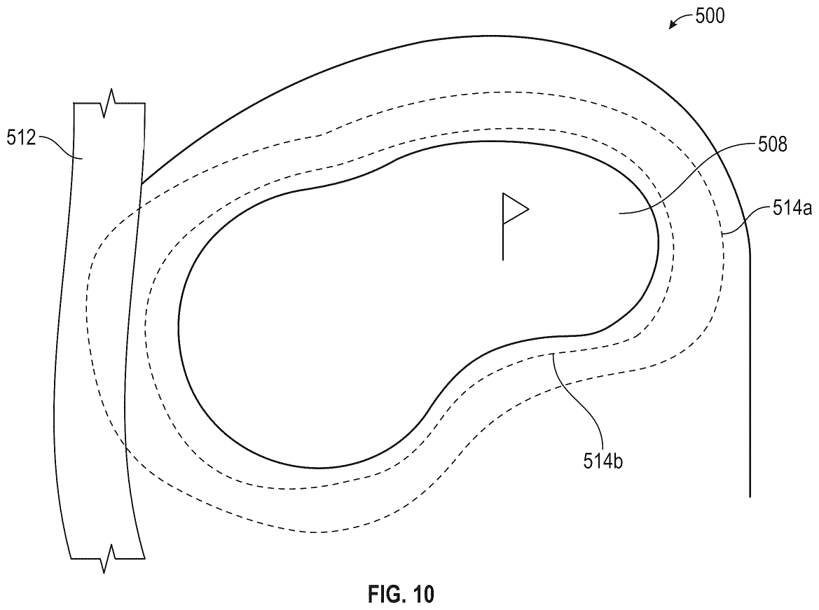

As shown in FIG. 10, the golf course 500 includes the green 508 and the cart path 512 with a first geofence 514a established around the green 508. The first geofence 514a may be a keep-out geofence as discussed in greater detail above. By way of example, the fleet monitoring and control system 200 may limit operation of the vehicle 10 to the second mode of operation in response to a determination that the vehicle 10 is operating in the restricted area defined by the first geofence 514a. As shown in FIG. 10, the first geofence 514a is established (e.g., unintentionally established) around at least a portion of the cart path 512. Because the first geofence 514a is established around at least a portion of the cart path 512, the fleet monitoring and control system 200 may limit operation of the vehicle 10 to the second mode of operation when the vehicle 10 drives along the cart path 512 and crosses into the first geofence 514a (e.g., crosses into the portion of the first geofence 514a established around the cart path 512). In other words, the fleet monitoring and control system 200 may inadvertently (e.g., undesirably) limit operation of the vehicle 10 even though the vehicle 10 is operating in a drivable area (e.g., the cart path 512).

In some embodiments, the fleet monitoring and control system 200 is configured to determine, based on (i) the violation data associated with the first geofence 514a and (ii) the location of the vehicle 10 relative to the cart path 512, that the first geofence 514a overlaps a portion of the cart path 512. By way of example, when the true location 516 of the vehicle 10 indicates the vehicle 10 is operating on the cart path 512 and in response to a violation of the vehicle 10 entering the first geofence 514a (e.g., when the fleet monitoring and control system 200 receives an indication of a violation), the fleet monitoring and control system 200 may determine that the first geofence 514a overlaps a portion of the cart path 512. By way of another example, when the true location 516 of the vehicle 10 indicates the vehicle 10 is operating on the cart path 512 and in response to violations of the first geofence 514a exceeding the violation threshold, the fleet monitoring and control system 200 may determine that the first geofence 514a overlaps a portion of the cart path 512. Based on the determination, the fleet monitoring and control system 200 is configured to suggest a new shape, size, position, boundary, etc., of the first geofence 514a, shown as second geofence 514b. The suggested second geofence 514b may be shaped, sized, positioned, etc., such that the second geofence 514b does not overlap the cart path 512. The first geofence 514a may be transitioned to the second geofence 514b in response to an input to the geofence GUI 600 approving the suggestion (e.g., the suggested second geofence 514b) by the fleet monitoring and control system 200. In some embodiments, the second geofence 514b is suggested and established (e.g., shaped, sized, positioned, etc.) based on boundaries of the cart path 512. By way of example, the boundaries of the cart path 512 may be determined based on an input to the golf course view panel 608 by the user identifying the boundaries and the second geofence 514b may extend along the identified boundaries of the cart path 512. By way of another example, the fleet monitoring and control system 200 may be configured to automatically detect the boundaries of the cart path 512 based on map data, image data, sensor data (e.g., from the sensors 90), etc. (e.g., using machine vision, machine learning, artificial intelligence, etc.), and the second geofence 514b may extend along the detected boundaries of the cart path 512.

While the second geofence 514b is described above with reference to the cart path 512, it should be understood that the second geofence 514b may be suggested and established based on the boundaries of any other drivable area of the golf course 500 in response to a determination by the fleet monitoring and control system 200 that a respective geofence 514 overlaps at least a portion of the drivable area. Further, while the establishment of the second geofence 514b is described above with reference to a single geofence 514, it should be understood that two or more geofences 514 of a campaign (e.g., the first campaign 616, the second campaign 620, etc.) may be modified and established in a similar manner as the second geofence 514b. By way of example, in response to a determination by the fleet monitoring and control system 200 that a respective geofence 514 included in a respective group of geofences 514 overlaps a portion a drivable area, the fleet monitoring and control system 200 may suggest a new geofence 514 that does not overlap the drivable area and may repeat the same process for all geofences 514 included in the respective group of geofences 514.

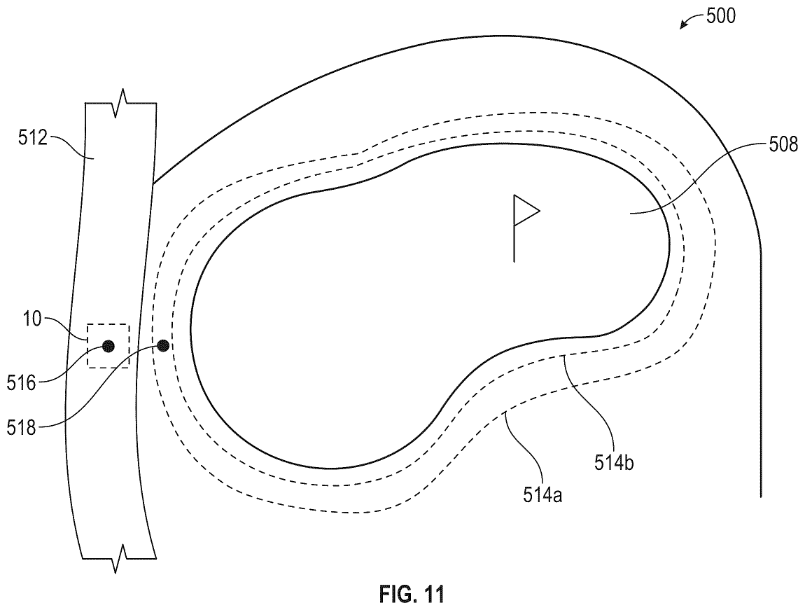

As shown in FIG. 11, the golf course 500 includes the green 508 and the cart path 512 with a first geofence 514a established around the green 508. The first geofence 514a may be a keep-out geofence as discussed in greater detail above. By way of example, the fleet monitoring and control system 200 may limit operation of the vehicle 10 to the second mode of operation in response to a determination that the vehicle 10 is operating in the restricted area defined by the first geofence 514a. As shown in FIG. 11, the true location 516 of the vehicle 10 is different than the tracked location 518 of the vehicle 10 (e.g., due to GPS drift as discussed in greater detail above). Specifically, the true location 516 of the vehicle 10 indicates that the vehicle 10 is operating in a drivable area (e.g., along the cart path 512) and the tracked location 518 of the vehicle 10 indicates that the vehicle 10 is operating in a restricted area (e.g., an area defined by the second geofence 514b). Because of the difference between the tracked location 518 and the true location 516, the fleet monitoring and control system 200 may determine, based on the GPS position, that the vehicle 10 is operating in the restricted area (e.g., near/on a green or tee box, near/on a hazard such as ground under repair, an area defined by a geofence, a non-drivable area, etc.) when in reality, the true location 516 of the vehicle 10 is not in the restricted area. In such an example, the fleet monitoring and control system 200 may undesirably limit the operation of the vehicle 10. Further, even though the first geofence 514a is established (e.g., shaped, sized, positioned, etc.) to not overlap the drivable area, the fleet monitoring and control system 200 may undesirably limit the operation of the vehicle 10 because the tracked location 518 indicates that the vehicle 10 is operating in the restricted area defined by the first geofence 514a.

In some embodiments, the fleet monitoring and control system 200 is configured to suggest, based on (i) the violation data associated with the first geofence 514a and (ii) the difference between the tracked location 518 and the true location 516, a new shape, size, position, boundary, etc., of the first geofence 514a, shown as second geofence 514b. By way of example, when the true location 516 of the vehicle 10 indicates the vehicle 10 is operating on the cart path 512 and the tracked location 518 of the vehicle 10 indicates the vehicle 10 is operating in the first geofence 514a (e.g., in response to a violation of the vehicle 10 entering the first geofence 514a, when the fleet monitoring and control system 200 receives an indication of a violation), the fleet monitoring and control system 200 may suggest the second geofence 514b. By way of another example, when the true location 516 of the vehicle 10 indicates the vehicle 10 is operating on the cart path 512 and in response to violations of the first geofence 514a exceeding the violation threshold, the fleet monitoring and control system 200 may suggest the second geofence 514b. The suggested second geofence 514b may be shaped, sized, positioned, etc., such that the tracked location 518 does not cross into the second geofence 514b when the vehicle 10 is operating on the cart path 512 (e.g., in a drivable area) such that the fleet monitoring and control system 200 does not undesirably limit the operation of the vehicle 10 because of GPS drift. The first geofence 514a may be transitioned to the second geofence 514b in response to an input to the geofence GUI 600 approving the suggestion (e.g., the suggested second geofence 514b) by the fleet monitoring and control system 200. In some embodiments, the second geofence 514b is suggested and established (e.g., shaped, sized, positioned, etc.) based on the GPS drift. By way of example, the boundaries of the second geofence 514b may be positioned at least a distance equal to the difference between the true location 516 and the tracked location 518 from the boundaries of the cart path 512.

While the second geofence 514b is described above with reference to the cart path 512, it should be understood that the second geofence 514b may be suggested and established based on the difference between the true location 516 and the tracked location 518 as the vehicle 10 operates in any other drivable area of the golf course 500 in response to a determination by the fleet monitoring and control system 200 that the tracked location 518 of the vehicle 10 is triggering a violation when the true location 516 indicates that the vehicle 10 is operating in the drivable area. Further, while the establishment of the second geofence 514b is described above with reference to a single geofence 514, it should be understood that two or more geofences 514 of a campaign (e.g., the first campaign 616, the second campaign 620, etc.) may be modified and established in a similar manner as the second geofence 514b. By way of example, in response to a determination by the fleet monitoring and control system 200 that the tracked location 518 of the vehicle 10 is triggering a violation of a respective geofence 514 included in a respective group of geofences 514 when the true location 516 indicates that the vehicle 10 is operating in the drivable area, the fleet monitoring and control system 200 may suggest a new geofence 514 to account for the difference between the true location 516 and the tracked location 518 and may repeat the same process for all geofences 514 included in the respective group of geofences 514.

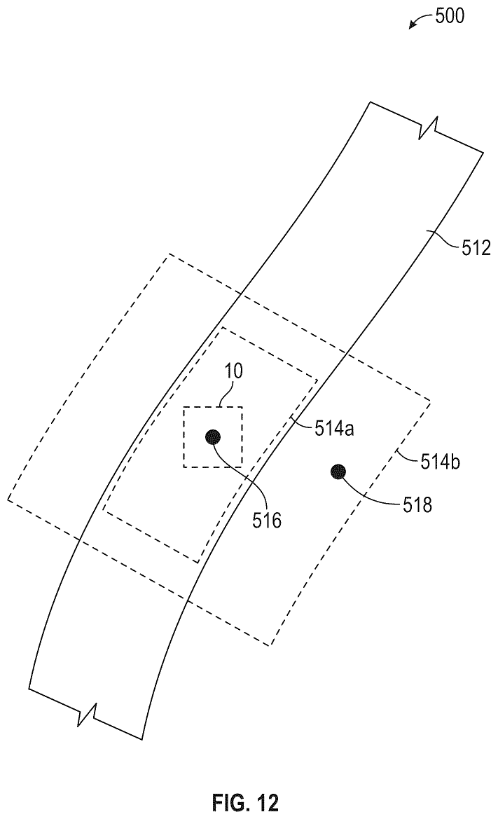

As shown in FIG. 12, the golf course 500 includes the cart path 512 with a first geofence 514a established around a portion of the cart path 512. The first geofence 514a may be an advertisement geofence or a message geofence as discussed in greater detail above. By way of example, the fleet monitoring and control system 200 may provide an advertisement (e.g., a picture, a video, an audio file, the advertisement 636, etc.) or a message (e.g., a text alert, a video alert, an audio alert, etc.) to the operator interface 48 and the occupants within the vehicle 10 in response to a determination that the vehicle 10 is operating in the area defined by the first geofence 514a. As shown in FIG. 12, the true location 516 of the vehicle 10 is different than the tracked location 518 of the vehicle 10 (e.g., due to GPS drift as discussed in greater detail above). Specifically, the true location 516 of the vehicle 10 indicates that the vehicle 10 is operating in the area defined by the first geofence 514a (e.g., along the cart path 512) and the tracked location 518 of the vehicle 10 indicates that the vehicle 10 is operating outside of the area defined by the first geofence 514a (e.g., off of the cart path 512). Because of the difference between the tracked location 518 and the true location 516, the fleet monitoring and control system 200 may determine, based on the GPS position, that the vehicle 10 is operating outside of the area defined by the first geofence 514a when in reality, the true location 516 of the vehicle 10 is not outside of the area defined by the first geofence 514a. In such an example, the fleet monitoring and control system 200 may undesirably not provide the advertisement or message to the operator interface 48 and the occupants within the vehicle 10.

In some embodiments, the fleet monitoring and control system 200 is configured to suggest, based on (i) the advertisement data associated with the first geofence 514a and (ii) the difference between the tracked location 518 and the true location 516, a new shape, size, position, boundary, etc., of the first geofence 514a, shown as second geofence 514b. By way of example, when the true location 516 of the vehicle 10 indicates the vehicle 10 is operating in the area defined by the first geofence 514a and the tracked location 518 of the vehicle 10 indicates the vehicle 10 is operating outside of the area defined by the first geofence 514a (e.g., in response to the absence of triggering an advertisement or message of the vehicle 10), the fleet monitoring and control system 200 may suggest the second geofence 514b. The suggested second geofence 514b may be shaped, sized, positioned, etc., to account for GPS drift such that the tracked location 518 indicates the vehicle 10 is operating in the area defined by the second geofence 514b when the vehicle 10 is operating on the cart path 512 (e.g., in a drivable area) such that the fleet monitoring and control system 200 provides the advertisement or message to the operator interface 48 and the occupants within the vehicle 10.

While the second geofence 514b is described above with reference to the cart path 512, it should be understood that the second geofence 514b may be suggested and established based on the difference between the true location 516 and the tracked location 518 as the vehicle 10 operates in any other drivable area of the golf course 500 where an advertisement or message geofence is established in response to a determination by the fleet monitoring and control system 200 that the tracked location 518 of the vehicle 10 is not triggering the advertisement or message to be provided when the true location 516 indicates that the vehicle 10 is operating in the area defined by the advertisement or message geofence. Further, while the establishment of the second geofence 514b is described above with reference to a single geofence 514, it should be understood that two or more geofences 514 of a campaign (e.g., the first campaign 616, the second campaign 620, etc.) may be modified and established in a similar manner as the second geofence 514b. By way of example, in response to a determination by the fleet monitoring and control system 200 that the tracked location 518 of the vehicle 10 is not triggering the advertisement or message to be provided when the true location 516 indicates that the vehicle 10 is operating in the area defined by the advertisement or message geofence, the fleet monitoring and control system 200 may suggest a new geofence 514 to account for the difference between the true location 516 and the tracked location 518 and may repeat the same process for all geofences 514 included in the respective group of geofences 514.

In some embodiments, the fleet monitoring and control system 200 temporarily transitions the first geofence 514a to the second geofence 514b to account for the difference between the true location 516 and the tracked location 518 (e.g., as discussed above with reference to FIG. 11 and FIG. 12) due to GPS drift. By way of example, the fleet monitoring and control system 200 may temporarily transition the first geofence 514a to the second geofence 514b for one hour, one day, two days, one week, etc., then may transition back to the first geofence 514a. In such an example, the difference between the true location 516 and the tracked location 518 caused by GPS drift may be temporary (e.g., due to temporary solar storms, weather conditions, among other temporary factors), and the fleet monitoring and control system 200 may therefor temporarily transition the first geofence 514a to the second geofence 514b to account for the temporary difference between the true location 516 and the tracked location 518.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf course management system comprising:
one or more processing circuits configured to:
provide a first graphical user interface on a first user device, the first graphical user interface configured to facilitate establishing one or more areas based on one or more user inputs received from the first user device;
establish a first area and a second area within a respective area based on the one or more user inputs;
monitor a location of a plurality of golf vehicles relative to the first area and the second area;
provide a second graphical user interface on a second user device of each of the plurality of golf vehicles;
provide, via the second graphical user interface, an advertisement when the location indicates that one or more golf vehicles of the plurality of golf vehicles are located in the first area and when the location indicates that one or more golf vehicles of the plurality of golf vehicles are located in the second area; and
aggregate advertisement data associated with the advertisement, wherein the advertisement data includes at least one of:
a view time of the advertisement based on a duration the advertisement is provided via the second graphical user interface;
an impression count of the advertisement based on a frequency the advertisement is provided via the second graphical user interface; or
a user interaction count of the advertisement based on user inputs with the advertisement provided via the second graphical user interface.

2. The golf course management system of claim 1, wherein the advertisement data includes the view time of the advertisement based on the duration the advertisement is provided via the second graphical user interface.

3. The golf course management system of claim 1, wherein the advertisement data includes the impression count of the advertisement based on the frequency the advertisement is provided via the second graphical user interface.

4. The golf course management system of claim 3, wherein the one or more processing circuits are configured to:
receive golfer data including a number of occupants of a respective golf vehicle of the plurality of golf vehicles; and
determine the impression count based on the number of occupants of the respective golf vehicle and the frequency the advertisement is provided via the second graphical user interface.

5. The golf course management system of claim 3, wherein the one or more processing circuits are configured to increase the frequency of advertisements provided via the second graphical user interface when the location indicates that a respective golf vehicle of the plurality of golf vehicles is in a high advertisement activity area.

6. The golf course management system of claim 1, wherein the advertisement data includes the user interaction count of the advertisement based on the user inputs with the advertisement provided via the second graphical user interface.

7. The golf course management system of claim 6, wherein the user interaction count of the advertisement includes whether the advertisement was interacted with, dismissed, or automatically removed.

8. The golf course management system of claim 1, wherein the one or more processing circuits are configured to automatically modify at least one of a shape, a size, or a position of the first area or the second area in response to an absence of the advertisement being provided via the second graphical user interface when the location of a respective golf vehicle indicates that the respective golf vehicle is located in the first area or the second area.

9. The golf course management system of claim 1, wherein the one or more processing circuits are configured to provide a suggestion to modify at least one of a shape, a size, or a position of the first area or the second area in response to an absence of the advertisement being provided via the second graphical user interface when the location of a respective golf vehicle of the plurality of golf vehicles indicates that the respective golf vehicle is located in the first area or the second area.

10. The golf course management system of claim 9, wherein the one or more processing circuits are configured to implement the suggested modification of the first area or the second area in response to receiving a user input from the first user device indicating an approval of the suggested modification of the first area or the second area.

11. The golf course management system of claim 1, wherein the one or more processing circuits are configured to identify a feature of the respective area at least partially included in the first area or the second area based on the advertisement data and the location of a respective golf vehicle of the plurality of golf vehicles.

12. The golf course management system of claim 1, wherein the first area is defined by a first geofence and the second area is defined by a second geofence.

13. The golf course management system of claim 1, wherein the each of the plurality of golf vehicles is one of a golf cart, an all-terrain vehicle, a utility task vehicle, a low speed vehicle, a lightweight or recreational vehicle, a lawnmower, a turf mower, a push mower, a ride-on mower, a stand-on mower, an aerator, a turf sprayer, or a bunker rake.

14. The golf course management system of claim 1, wherein the one or more processing circuits includes at least one of (i) a first processing circuit configured to be located on a respective golf vehicle of the plurality of golf vehicles or (ii) a second processing circuit configured to be located remote from the respective golf vehicle.

15. A golf course management system comprising:
one or more processing circuits configured to:
provide a first graphical user interface on a first user device, the first graphical user interface configured to facilitate establishing one or more areas based on one or more user inputs received from the first user device;
establish a first area and a second area within a respective area based on the one or more user inputs;
monitor a location of a plurality of golf vehicles relative to the first area and the second area;
provide a second graphical user interface on a second user device of each of the plurality of golf vehicles;
provide, via the second graphical user interface, an advertisement when the location indicates that one or more golf vehicles of the plurality of golf vehicles are located in the first area and when the location indicates that one or more golf vehicles of the plurality of golf vehicles are located in the second area; and
aggregate advertisement data associated with the advertisement, the advertisement data including:
a view time of the advertisement based on a duration the advertisement is provided via the second graphical user interface;
an impression count of the advertisement based on a frequency the advertisement is provided via the second graphical user interface; and
a user interaction count of the advertisement based on user inputs with the advertisement provided via the second graphical user interface.

16. The golf course management system of claim 15, wherein the one or more processing circuits are configured to:
receive golfer data including a number of occupants of a respective golf vehicle of the plurality of golf vehicles; and
determine the impression count based on the number of occupants of the respective golf vehicle and the frequency the advertisement is provided via the second graphical user interface.

17. The golf course management system of claim 15, wherein the one or more processing circuits are configured to increase the frequency of advertisements provided via the second graphical user interface when the location indicates that a respective golf vehicle of the plurality of golf vehicles is in a high advertisement activity area.

18. The golf course management system of claim 15, wherein the one or more processing circuits are configured to modify or suggest modifying at least one of a shape, a size, or a position of the first area or the second area in response to an absence of the advertisement being provided via the second graphical user interface when the location of a respective golf vehicle of the plurality of golf vehicles indicates that the respective golf vehicle is located in the first area or the second area.

19. The golf course management system of claim 15, wherein the one or more processing circuits are configured to identify a feature of the respective area at least partially included in the first area or the second area based on the advertisement data and the location of a respective golf vehicle of the plurality of golf vehicles.

20. A golf course management system comprising:
one or more processing circuits configured to:
provide a first graphical user interface on a first user device, the first graphical user interface configured to facilitate establishing one or more geofences based on one or more user inputs received from the first user device;
establish a first geofence and a second geofence within a respective area based on the one or more user inputs;
monitor a location of a plurality of golf vehicles relative to the first geofence and the second geofence;
provide a second graphical user interface on a second user device of each of the plurality of golf vehicles;
provide, via the second graphical user interface, an advertisement when the location indicates that one or more golf vehicles of the plurality of golf vehicles are located in the first geofence and when the location indicates that one or more golf vehicles of the plurality of golf vehicles are located in the second geofence;
aggregate advertisement data associated with the advertisement;
identify a drivable area of the respective area at least partially overlapped by the first geofence or the second geofence based on the advertisement data and the location of a respective golf vehicle of the plurality of golf vehicles; and
increase a frequency of advertisements provided via the second graphical user interface when the location indicates that the respective golf vehicle is in a high advertisement activity area.

21-40. (canceled)
